(19) United States
(12) Patent Application Publication
(10) Pub. No.: US 2002/0152955 A1
(43) Pub. Date: Oct. 24, 2002

(54) APPARATUS AND METHOD FOR DEPOSITING AN ELECTROLESS SOLUTION

(76) Inventors: YEZDI DORDI, PALO ALTO, CA (US); LEOPOLDO FRANCISCO CASTRO, SANTA CLARA, CA (US)

Correspondence Address: APPLIED MATERIALS, INC., 2881 SCOTT BLVD. M/S 2061, SANTA CLARA, CA, 95050, US

(21) Appl. No.: 09/476,438

(22) Filed: Dec. 30, 1999

(51) Int. Cl. B05C 11/00

(52) U.S. Cl. 118/63; 118/612

(57) ABSTRACT

An apparatus and associated method that dispenses an electrolyte solution on an object. The apparatus comprises a storage chamber and a dispensing portion. The storage chamber is configured to hold the electrolyte solution. The dispensing portion is configured to dispense the electrolyte solution on the object.

### BACKGROUND OF THE DISCLOSURE

1. Field of the Invention

The invention relates to metal deposition systems. More particularly, the invention relates to metal deposition systems in which an electrolyte solution is applied to an object.

2. Description of the Prior Art

Sub-quarter micron, multi-level metallization is an important technology for the next generation of ultra large scale integration (ULSI). Reliable formation of these interconnects features permits increased circuit density, improves acceptance of ULSI, and improves quality of individual processed wafers. As circuit densities increase, the widths of vias, contact points and other features, as well as the width of the dielectric materials between the features, decrease. However, the height of the dielectric layers remains substantially constant. Therefore, the aspect ratios for the features (i.e., the height or depth divided by the width) increases. Many traditional deposition processes, such as physical vapor deposition (PVD) and chemical vapor deposition (CVD), presently have difficulty providing uniform features having aspect ratios greater than 4/1, and particularly greater than 10/1. Therefore, a great amount of ongoing effort is directed at the formation of void-free, nanometer-sized uniform features having high aspect ratios of 4/1, or higher.

Electroplating, previously limited in integrated circuit design to the fabrication of lines on circuit boards, now is used to fill semiconductor device vias and contact points. Metal electroplating, in general, can be achieved by a variety of techniques. One embodiment of an electroplating process involves initially depositing a barrier layer over the feature surfaces of the wafer; depositing a conductive metal seed layer over the barrier layer, and then layering a conductive metal (preferably copper) over the seed layer to fill the structure/feature. Finally, the deposited layers are planarized by, e.g., chemical mechanical polishing (CMP), to define a conductive interconnect feature.

In electroplating, layering of a metallic layer is accomplished by delivering electric power to the seed layer and then exposing the wafer plating surface to an electrolytic solution containing the metal to be deposited. The seed layer adheres to the subsequently deposited metal layer (as well as a conformal layer) to provide for uniform growth of the metal layer thereover. A number of obstacles impair consistently reliable electroplating of metal, especially copper, onto wafers having nanometer-sized, high aspect ratio, features. These obstacles include non-uniform power distribution and current density to different portions of the seed layer across the wafer plating surface.

In addition to the electroplating, many of the traditional systems such as PVD and CVD require a deposited seed layer to enhance the adhesion of the deposited layer. One goal in depositing such seed layers is ensuring that the seed layer is consistently applied across the entire topography of the object Unfortunately, this goal is not always realized in certain irregularly shaped features. After the deposition process from certain prior art systems, the edges of features (comprising trenches and vias) formed in the object have a thinner layer than the bottom of the features or the step above the features as a result of the orientation of the respective surfaces. Discontinuities may actually form in the layer deposited on the sides of the features due to the direction in which the seed layer is deposited.

One prior art technique that provides a continuous seed layer over features involves depositing a thicker seed layer over the object. Such thicker seed layers may have such difficulties as “choking off” openings to the features. Additionally, thicker seed layers require more seed material that is more expensive.

One technique for depositing a metal layer over a seed layer involves electroless deposition. In such systems, a metal, typically nickel or copper contained in the electrolyte solution is deposited on the object utilizing an electrolyte bath comprising the electrolyte solution.

Electroless plating has been accomplished either by immersion electroless systems of by spray electroless systems. In immersion electroless systems, the surface to be coated is immersed in the electrolyte bath. The electroless reaction is catalyzed by the seed layer, thereby increasing the metal thickness. By comparison, the electrolyte solution is sprayed over the object in spray electroless systems.

Electroless systems using an electrolyte bath (for both spray and immersion systems) are among the most expensive, and complex, substrate processing equipment to operate. The expense is primarily associated with the large quantity of electrolyte solution contained in the electrolyte bath used in both immersion and spray type electroless systems. Additionally, there are difficulties with controlling the balance of chemical components (and stabilizing the balance) within the electrolyte bath in either the spray or immersion electroless systems.

The electrolyte solution contained in either the spray or immersion type baths is re-used, primarily due to the expense of the electrolyte solution and waste disposal. To reuse the solution, the electrolyte solution must be continually monitored and replenished during operation to maintain the chemical balance. Chemical imbalance during use may result from a variety of situations including impurities in the solution and a large quantity of metal being deposited on the object during metal layering. To ensure that the reactants are balanced in the prior art bath systems, sensors and control systems are used that respectively determines and control the concentration of different chemical components in the bath. However, the concentrations of the chemical components can change rapidly, particularly if a large amount of metal is being deposited on the object.

If any stray (metal or non-metallic) flakes that could catalyze the electroless reaction enter the electrolyte bath, the copper in the electrolyte solution could precipitate out resulting in a chemical imbalance in the electrolyte bath. Also, the precipitated flakes may create physical “chunks” that limit the consistency of the resulting deposited layer that is deposited on the object.

Electroless systems are very dynamic, and rapidly change on a local basis when the object is inserted into the bath. This dynamic nature results largely from the use of a reducing agent. Reducing agents, by their nature, are unstable when combined with metals to form electrolyte solution. The longer the duration that an electrolyte solution is kept, the more likely that it will become unstable. Control of the electrolyte bath therefore becomes especially difficult. If the electrolyte bath solution gets out of balance, then the entire electrolyte bath has to be replaced or the deposition and/or the adhesion effectiveness of the deposited layer will be poor. The expense of the sensors and control systems for such electrolyte bath systems is considerable. There is also a possibility of malfunctioning due to the inherent complexity.

Mixing the chemical components manually can be laborious. In addition, such a repetitive task leads to errors in the relative quantities of chemical components. Making the mixture of the electrolyte solution automatic would lead to a more precise and reliable chemistry, especially over the long term.

Therefore, a need exists in the art for a simplified electroless plating system that consumes a small volume of relatively stable electrolyte solution compared to prior art systems.

### SUMMARY OF THE INVENTION

Many disadvantages associated with the prior art are overcome with the present invention that dispenses an electrolyte solution to an object. In one aspect, the present invention provides a processing apparatus which includes a storage chamber and processing cell having a dispensing portion disposed at least partially therein. The storage chamber is configured to hold the electrolyte solution. The dispensing portion is configured to dispense the electrolyte solution on the object. In another aspect, a method of depositing a metal on a substrate is provided. The method generally includes depositing on a substrate in a processing cell and delivery of electrolyte to the substrate.

### BRIEF DESCRIPTION OF THE DRAWINGS

The teachings of the present invention can be readily understood by considering the following detailed description in conjunction with the accompanying drawings, in which:

FIG. 1 shows a schematic diagram of an electrolyte solution deposition system of one embodiment;

FIG. 2 shows a schematic view of one embodiment of mixing or storing chamber shown in FIG. 1;

FIG. 3, comprising FIGS. 3A to 3C, shows a cross-sectional view of a progression comprising applying an electrolyte solution to an object including a feature including side and bottom portions, the object having a seed layer requiring patching along the side portions in FIG. 3A, FIGS. 3B and 3C show the patching;

FIG. 4, comprising FIGS. 4A and 4B, is a cross sectional view of one embodiment of a progression comprising applying electrolyte solution to a feature using a liquid puddle, the liquid puddle is of the type that may be applied by the embodiment shown in FIG. 1;

FIG. 5 is a flow chart of one embodiment of a method of operation of the electrolyte solution deposition system of FIG. 1;

FIG. 6 is another embodiment of a mixing or storing chamber from that illustrated in FIGS. 1 and 2; and

FIG. 7 is a cross-sectional view of another embodiment of circumferential dam from that shown in FIG. 1.

To facilitate understanding, identical reference numerals have been used, where possible, to designate identical elements that are common to the figures.

### DETAILED DESCRIPTION

After considering the following description, those skilled in the art will clearly realize that the teachings can be readily utilized in any deposition system in which any electrolyte solution is deposited on an object. An example of such an object includes a substrate, such as a semiconductor wafer.

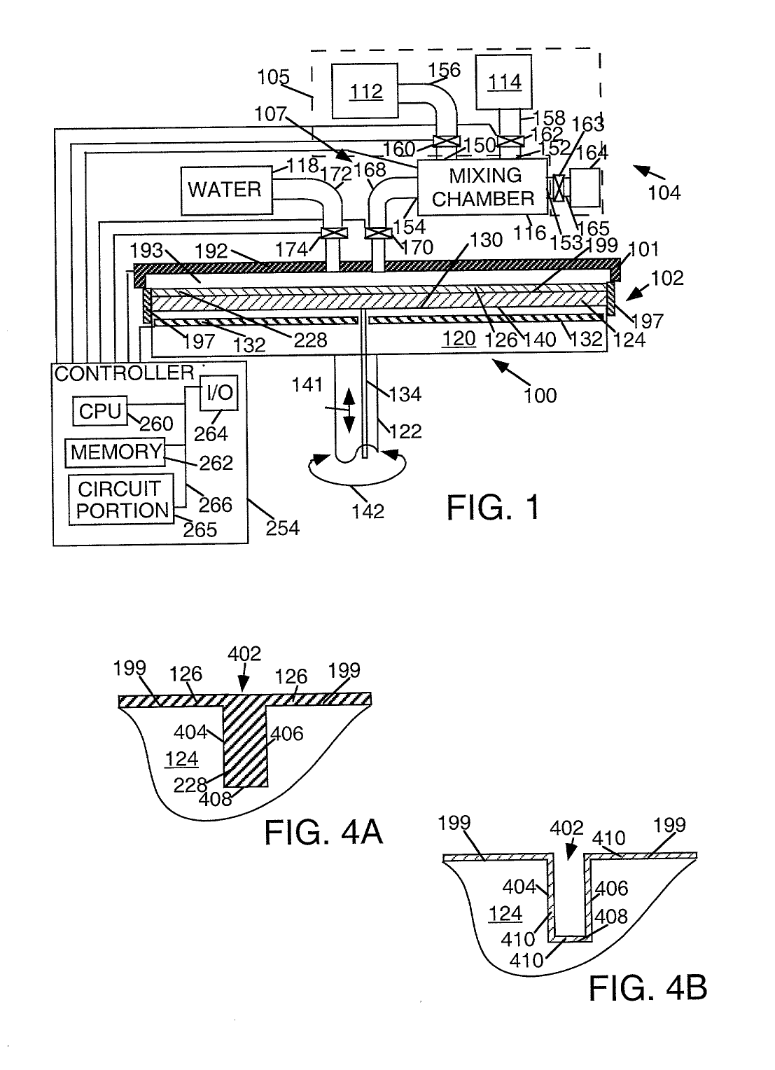

FIG. 1 shows an electrolyte solution dispensing system 100 that applies electrolyte solution to an object portion 124 in accordance with one embodiment. The electrolyte solution dispensing system 100 comprises an enclosure 101, an object support portion 102, an electrolyte solution dispensing portion 104. The electrolyte solution-dispensing portion 104 comprises a chemical source component 105, a mixing or storing chamber 116 (which may be a storing chamber and/or a mixing chamber in certain embodiments that receive a premixed electrolyte solution), and a dispensing portion 107. The chemical source component 105 comprises a metal solution supply 112 (typically comprising a complexing agent), a reducing agent supply 114, and a first water supply 164 in addition to the associated valves and conduits. The object support portion 102 comprises a pedestal 120, a displacement member 122, a removable object 124 such as a substrate or a wafer. A liquid puddle 126 comprising electrolyte solution is provided on the object to accomplish electroplating, as described below. In a preferred embodiment, the displacement member 122 comprises a shaft displaceably coupled to an actuator. While a detailed chemical source component 105 is depicted in FIG. 1, it is within the intended scope to provide any system what could provide a desired mixture of the chemical source components 105.

The pedestal 120 is disposed at least partially in the enclosure and includes an upper surface 130 that is generally horizontally oriented and is configured to receive an object 124. The pedestal 120 may include heating elements 132 that are configured to apply heat directly to the pedestal 120, and in this manner, control the temperature of the object 124. In electroplating copper from copper sulfate, for example, it is desired to maintain the electrolyte solution between 40° C. and 70° C. to enhance the electroless process based upon the heat imparted by the pedestal 120. A clamp or clamp ring (not shown) can be provided to hold the object 124 on the pedestal. The displacement member 122, such as a shaft displaced by an actuator, provides two types of motion to the pedestal 120, and to an object 124 and the liquid puddle 126 disposed thereupon during processing.

The first type of motion of displacement member 122 is in a vertical direction indicated by arrow 141 that enables the object 124 to move towards, or away from, the enclosure 101. For example, the displacement member 122 is displaced downwardly (the direction as shown in FIG. 1) when a new object 124 is being loaded onto, or a processed object 124 is to be removed from, the pedestal 120. The displacement member 122 of FIG. 1 is displaced upwardly into the enclosure 101 for processing.

The second type of motion of the displacement member 122 is an oscillatory, vibratory, or straight rotational motion in a rotational direction as indicated by arrow 142. The oscillatory motion is used only in some embodiments of electrolyte solution dispensing systems 100 and acts to improve distribution of the electrolyte solution across the object. In processing cells comprising a pedestal 120 that does not vibrate, oscillate, or rotate, a considerable amount of electrolyte solution (e.g. about 50 ml) is applied to the upper surface of an object 124 to ensure that the electrolyte solution covers the upper surface of the object.

In those electrolyte solution dispensing systems 100 in which the pedestal 120 does oscillate, vibrate, or rotate, a circumferential dam 197 is preferably connected to and extends about the periphery of the pedestal 120. The circumferential dam 197 rises slightly above the level of the object 124 and defines a circumferential wall around object 124, thus forming a liquid restraint capable of maintaining the liquid puddle 126 above object 124. The circumferential dam 197 allows the liquid puddle 126 to uniformly form above the object 124 without dripping off the edge of the object.

Another configuration of circumferential dam 702, shown interacting with a portion of the object 124 such as a wafer, is shown in FIG. 7. The circumferential dam 702 comprises an annular clamp ring 704 and a seal 706 such as an O-ring. The annular clamp ring 704 extends about the periphery of an upper surface 708 of the object 124. The annular clamp ring 704 is similar is of suitable weight to maintain an object 124 such as a semiconductor wafer on the upper surface of the pedestal during processing without relative motion. The seal 702 is selected to be secured to the annular clamp ring such that it forms a seal between the upper surface 708 and the annular clamp ring 704 sufficient to maintain the liquid puddle 228 above the upper surface 708. Additionally, the seal 706 is selected to resist a reaction with the electrolyte solution forming the liquid puddle 228.

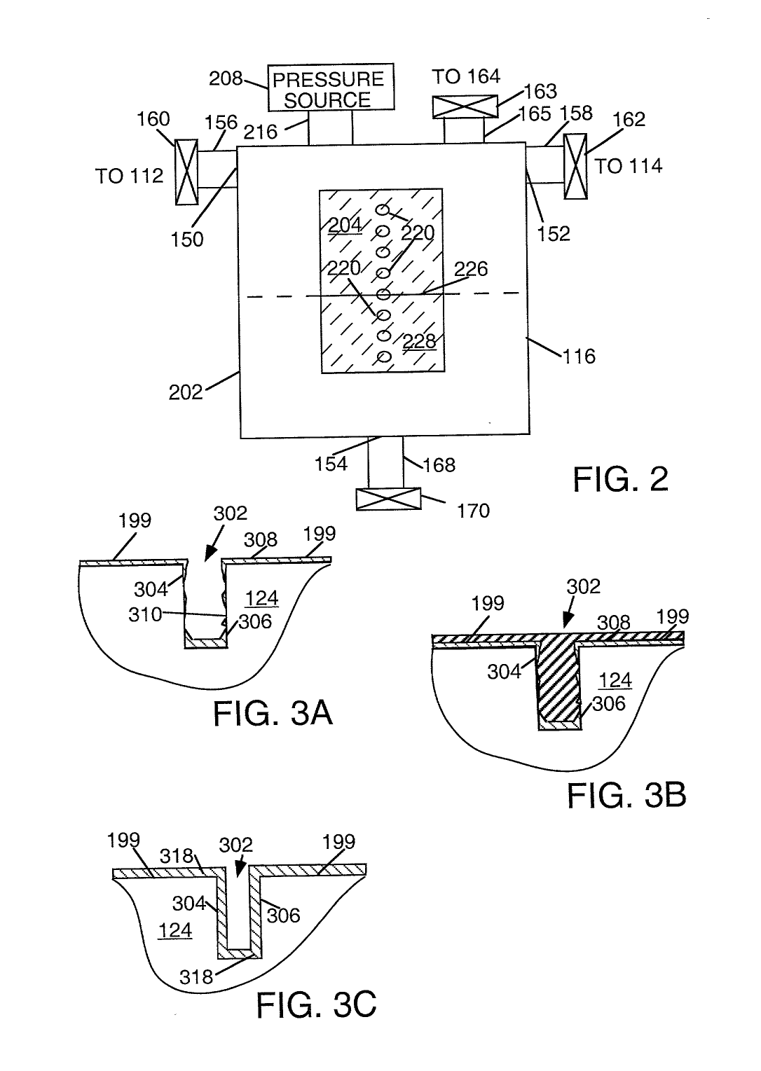

The structure of the electrolyte solution-dispensing portion 104 is now described relative to FIGS. 1 and 2. The mixing or storing chamber 116 comprises a first input port 150, a second input port 152, a third input port 153, and an output port 154. The metal solution supply 112 is fluidly coupled to the first input port 150 by a conduit 156. The reducing agent supply 114 is fluidly coupled to the second input port 152 by a conduit 158. The first water supply 165 is fluidly coupled to the third input port 153 by conduit 165.

It is envisioned that most of the electrolyte solution dispensing portion 104 may be located outside of the enclosure 101 with conduit 168, for example, passing through the enclosure wall. An advantage of this later embodiment is that an upper wall 192 of the enclosure 101 preferably is spaced from the puddle 126 by a very small distance such as 5-20 mm. This reduces the volume enclosed by the enclosure 101, and limits the evaporation of the liquid puddle 126 into an interior space 193 defined between the enclosure 101 and the liquid puddle 126. In one embodiment, the liquid puddle may contact the upper wall 192. Additionally, pressure (such as from a nitrogen source—not shown) may be applied to the enclosure 101 to further reduce evaporation of the liquid puddle 126 into interior space 193. This limiting of evaporation of the liquid puddle 126 acts to maintain the chemical balance therein. Therefore, the time that the liquid puddle 126 can remain on the object 130 (without changes in the chemistry of, and the stability of, the liquid puddle) is increased.

A first control valve 160 is inserted into conduit 156 to control the flow of a metal solution from the metal solution supply 112 into the mixing or storing chamber 116. A second control valve 162 is inserted into the conduit 158 to control the flow of the reducing agent from the reducing agent supply 114 into the mixing or storing chamber 116. A third control valve 163 is inserted into the conduit 165 to control the flow of water from the first water supply 164 to the mixing or storing chamber 116. The relative rate of fluid flow through the first control valve 160, the second control valve 162, and the third control valve 163 controls the concentration of the copper (from the metal solution supply 112), the reducing agent (from the reducing agent supply 114), and water (from the first water supply 164) into the mixing or storing chamber 116. The control valves 160, 162, and 163 typically control flow rate according to the weight of the liquid distributed based upon, e.g., a look-up table. Therefore, the controller 254 and/or an operator would have to correlate the desired concentrations with the corresponding weights of the liquids located upon the look-up table. In this manner, the concentration of the different agents that combines to form the electrolyte solution 228, can be precisely controlled in the mixing or storing chamber 116.

The electrolyte solution 228 is dispensed from the mixing or storing chamber through a conduit 168. This may be aided by the application of pressure from the pressure source 208 shown in FIG. 2 which forces the electrolyte solution 228 out of the mixing or storing chamber 116 via conduit 168, as described below. A valve 170 is integrated into conduit 168 to control the rate at which electrolyte solution 228 is dispensed from the mixing or storing chamber 116 onto the object 124 to partially form the liquid puddle 126. Deionized water is dispensed as desired from the second water supply 118 through the conduit 172 directly over the object 124. The rinse water from the second water supply 118 acts to wash away the liquid puddle 126, which stops any further resultant deposition from the electrolyte solution. Though the position of conduit 172 is shown as separated from conduit 168 by a considerable distance, it is desirable to locate them as close together as possible. Valve 174 is integrated in conduit 172 to control the rate at which rinse water is dispensed from the second water supply 118 onto the object 124.

Those valves (160, 162, and 170) and conduits (156, 158, 168) that interact with chemicals may be formed from a plastic material selected to resist degradation when exposed to the electrolyte solution in a preferred embodiment. The valves may preferably be solenoid valves or other types of quick actuating valves. The valves 160, 162, 163, and 170 used to apply a desired concentration of chemicals or liquids preferably dispense the liquids according to their weights using, for example, flow controllers. Thus, the resultant chemical concentration flow rates can be either computed by controller 254, or calculated by the operator. Though the conduits 168 and 172 are shown in FIG. 1 as a rigid member, the conduits may actually be formed from flexible plastic that is supported, for example, by a adjustable, rigid arm portion (not shown). Alternatively, the adjustable arm portion may include the conduits 168 and/or 172 as an integrated unit. The purpose of using such an adjustable arm portion is to be able to adjust the location where the electrolyte solution 228 is dispensed relative to the object 124.

In one embodiment, the relative opening of the valves 160, 162, and 163 will determine the respective concentration of the metal solution, reducing agent, and mix water in the electrolyte solution 228 in the mixing or storing chamber 116. Additionally, the timing of the opening and closing of both valves 170 and valve 174 will determine the timing of the application of electrolyte solution 228 and rinse water applied to the object 124. A controller 254 as described below controls the relative positions and timing of the valves 160, 162, 163, 170 and 174.

In an alternate embodiment in which the mixed electrolyte solution is poured directly into the mixing or storing chamber 116 from a beaker, the controller 254 may still control timing and position of valves 170 and 174. This controls the respective application of electrolyte solution and rinse water on the object 124.

In another embodiment, valves 170 and 174 are eliminated, and the operator manually pours the electrolyte solution and/or rinse water, from separate containers, onto the upper surface of the object 124. As should be evidenced at this point, it is envisioned that the electrolyte solution dispensing system 100 can be made as automated under the control of controller 254 or manual as desired. Even in those embodiments that have a controller 254 controlling operation of any one(s) of the valves 160, 162, 163, 170, and 174, it is envisioned that the controller 254 can be overridden to provide manual mixing and/or application of the chemicals, as desired.

The mixing or storing chamber 116 includes chamber body 202, chamber window 204, and a pressure source 208. The chamber body 202 is preferably formed from plastic or some other chemically resistant material. Additionally, the mixing or storing chamber 116 has to be able to withstand pressures sufficient to dispense the electrolyte solution 228 located therein. The chamber window 204 is preferably formed from quartz to provide a line of sight into the mixing or storing chamber 116 for the operator. This visibility for the operator ensures that the operator can determine the level and/or quality (e.g. hardness) of electrolyte solution. One or more level sensors 220 are also located in the mixing or storing chamber 116 to determine the level of the electrolyte solution 228 within the mixing or storing chamber 116. The chamber window 204 can be used either in combination with, or as an alternative to, the level sensors 220. The level sensors 220 may be either a plurality of individual sensors, as shown, a single array sensor, or any type of known sensor that can determine the level of the electrolyte solution.

The mixing or storing chamber 116 acts as a point of use dispenser of electrolyte solution. It is desired to limit any reaction of the electrolyte solution in the mixing or storing chamber 116 until it is applied to the object. Thus, the temperature of the electroless premix in the mixing or storing chamber 116 may be reduced (using, e.g., refrigeration coils embedded in the mixing or storing chamber 116) to a point where the reaction rate of the electrolyte solution is limited.

The mixing or storing chamber 116 is preferably relatively small, and the pressure applied by the pressure source 208 upon the electrolyte solution 228 contained within the mixing or storing chamber 116 causes the chemical constituents in the mixing or storing chamber to be thoroughly mixed. Spiral channels or baffles may be formed in the mixing or storing chamber to further assist in the mixing of the electrolyte solution 228. Any other known mixing device such as a device that vibrates the mixing and storing chamber 116 is intended to be within the scope. Such a thorough mixing of the electrolyte solution 228 is performed before it is dispensed to form a portion of the liquid puddle 126 positioned on the object 124.

The pressure source 208 is fluidly connected to the mixing or storing chamber 116 via conduit 216 as shown in FIG. 2. The pressure source can inject a gas, e.g. nitrogen, under sufficient pressure to expel the electrolyte solution 228 contained in the mixing or storing chamber 116 through the conduit 168 and valve 170 to form the liquid puddle 126 on top of the object 124. When pressure is applied from the pressure source 208, the valves 160 and 162 shown in FIG. 1 must be closed. Otherwise, the pressure applied to the mixing or storing chamber 116 (as well as the electrolyte solution 228 contained in the mixing or storing chamber) will be expelled through the conduits 156 and 158, respectively. The pressure that must be applied from the pressure source is dependent upon the particular configuration of the electrolyte solution dispensing system 100. The pressure and gas applied from the pressure source 208 is selected to limit excessive evaporation of the electrolyte solution 228 that is contained within the mixing or storing chamber 116.

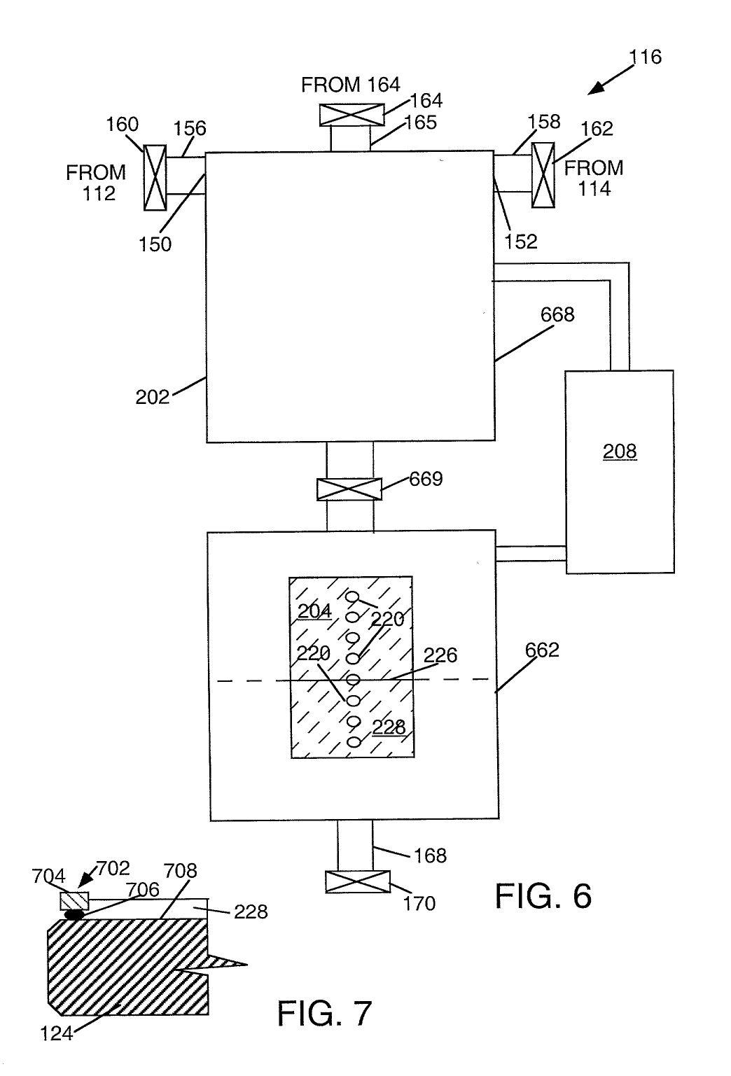

FIG. 6 shows another embodiment of a mixing or storing chamber 116 that supplies the electrolyte solution to conduit 168. This embodiment uses the mixing or storing chamber 116 to perform online metering, mixing, and dilution of the chemicals. More specifically, the mixing or storing chamber 116 delivers an electrolyte solution to the object. The mixing or storing chamber 116 comprises a first mixing or storing chamber 668, a second mixing or storing chamber 662, the plurality of valves 160, 163, 162, 170, and 669, the first water supply 164, a metal solution supply 112, a reducing agent supply 114, and a pressure source 208. Metal solution, mix water, and reducing agent are supplied under pressure from metal solution supply 112, the first water supply 164, and the reducing agent supply 114, respectively. The valves 160, 162, and 164 are each configured to dispense a controllable, measurable quantity by weight.

The valves 160, 162, and 164 permit a prescribed weight of the chemical source components respectively from the metal solution, the reducing agent, and the water to pass to the first mixing or storing chamber 668 respectively from the metal solution supply 112, the reducing agent supply 114, and the first water supply 164. Thus, if the operator wishes to produce a specific chemical combination, the controller 254 computes the respective weights of water from the first water supply 164, metal from the metal solution 112, and reducing agent from the reducing agent supply 114. The respective weights have to be able to be repeatably mixed upon demand (or calculated by the operator) to provide a nearly identical chemical mixture regardless of the number of times that the electrolyte solution is mixed. The controller 254 can compute the respective weights by storing the weights of water, certain metal solutions, and certain reducing agents contained in the supplies 164, 112, and 114 that are commonly used in the electrolyte solution dispensing portion 100. The controller 254 may prompt the operator as to the specific chemical make-up of the electrolyte solution. The controller 254 then produces and stores the electrolyte solution according to the information stored by the controller 254 (for example, the range of temperature, pressure, and pH for a specific electrolyte solution. These parameters may also be applied to the interior space 193 and/or the pedestal 120 under the influence of the controller 254.

The first mixing or storing chamber 668 and the second mixing or storing chamber 662 interact to mix the combination of water from the first water supply 164, the metal solution from the metal solution supply 112, and the reducing agent from the reducing agent supply 114. The first mixing or storing chamber 668 acts to mix the chemical components inserted therein into electrolyte solution. The second mixing or storing chamber 662 acts as a holding tank that contains the mixed electrolyte solution in a form that is ready for application. The first mixing or storing chamber 668 is usually empty until it is desired to provide more electrolyte solution into the second mixing or storing chamber 662. The two mixing or storing chambers 668, 662 act as a point of use dispenser of electrolyte solution. It is desired to limit any reaction of the electrolyte solution until it is applied to the object. As such, the temperature of the electroless premix in the second mixing or storing chamber may be reduced to a temperature where the chemical reaction rate of the electrolyte solution is reduced.

When it is desired to mix more electrolyte solution, then small percentages of the total chemical source components from chambers 164, 112, and 114 can alternately be introduced into the first mixing or storing chamber 168 to enhance the mixing procedure. This alternate cycling of the insertion of the chemical source components is repeated as desired to fill the first mixing or storing chamber 668 to a desired level. This alternating of the chemicals can also be applied to the application of chemicals to the mixing or storing chamber 116 in the embodiment shown in FIG. 2. The pressure that supplies each of these chemical source components acts to mix the chemical source components as a result of diffusion into the electrolyte solution. The action of expelling electrolyte solution from the second mixing or storing chamber 668 into the first mixing or storing chamber 662 further acts to mix the electrolyte solution. Both the first mixing or storing chamber 668 and the second mixing or storing chamber 662 are formed as, for example, distinct two-liter tanks. Pressure is selectively applied to both the first mixing or storing chamber 668 and the second mixing or storing chamber 662 from the pressure source 208 under the control of the controller 254. The pressure source 208 typically applies nitrogen gas under a prescribed pressure.

When it is desired to expel the electrolyte solution from the second mixing or storing chamber 168 into the first mixing or storing chamber 162, valves 160, 162 and 163 are first closed by controller 254. This closing of the valves 160, 162, 163 ensures that the sources of metal solution supply, reducing agent supply, and deionized water at 112, 114, and 164 respectively, do not become contaminated. Pressure source 208 is then applied to the second mixing or storing chamber 168 but not the first mixing or storing chamber 162. Controller 254 then opens valve 170. The pressure in second mixing or storing chamber 168 forces the electrolyte solution into the first mixing or storing chamber 162, which further mixes the electrolyte solution by agitation such as by vibration, oscillation, or rotation described above.

When the second mixing or storing chamber 162 is filled as desired, the controller 254 closes valve 170 and applies pressure from pressure source 208 to the second mixing or storing chamber 162. This occurs instead of applying pressure to the depressurized first mixing or storing chamber 168. Pressure from the pressure source 208 acts to expel the electrolyte solution from the first mixing or storing chamber 162 into conduit 168 when valve 170 is opened. During operation, first mixing or storing chamber 168 and second mixing or storing chamber 162 interact to provide a constant and fresh supply of electrolyte solution that may be used to apply the liquid puddle 126 to the top of the object 124. In addition, the mixing and storing chamber 116 and 168 in the respective embodiments shown in FIG. 2 and FIG. 6 both provide a very accurate and highly repeatable system capable of providing a desired amount of electrolyte solution (of an accurate and adjustable chemistry controlled by the operator.

The chemicals can be measured into a mixing module in one of three ways: 1) from pressurized house facility lines, 2) from a 55 gallon drum of chemicals, or 3) from an online generation unit. As suggested above, the above chemicals can also be inserted into beakers or other containers, and dispensed directly upon the object to form the liquid puddle in one embodiment.

The controller 254 controls operation of the electrolyte solution dispensing system 100, and comprises central processing unit (CPU) 260, memory 262, circuit portion 265, input output interface (I/O) 264, and bus 266. The controller 254 controls the mixing and dispensing of the electrolyte solution from the mixing or storing chamber 116. In addition, the controller controls the parameter that the interior space 193, the pedestal 120, and the object 124 are being maintained at based upon the chemistry of the electrolyte solution. For example, if the electrolyte solution must be applied at a specific temperature range, then the temperature of the heating element 132 (that is thermally coupled to the object 124 via pedestal 124) is modified accordingly.

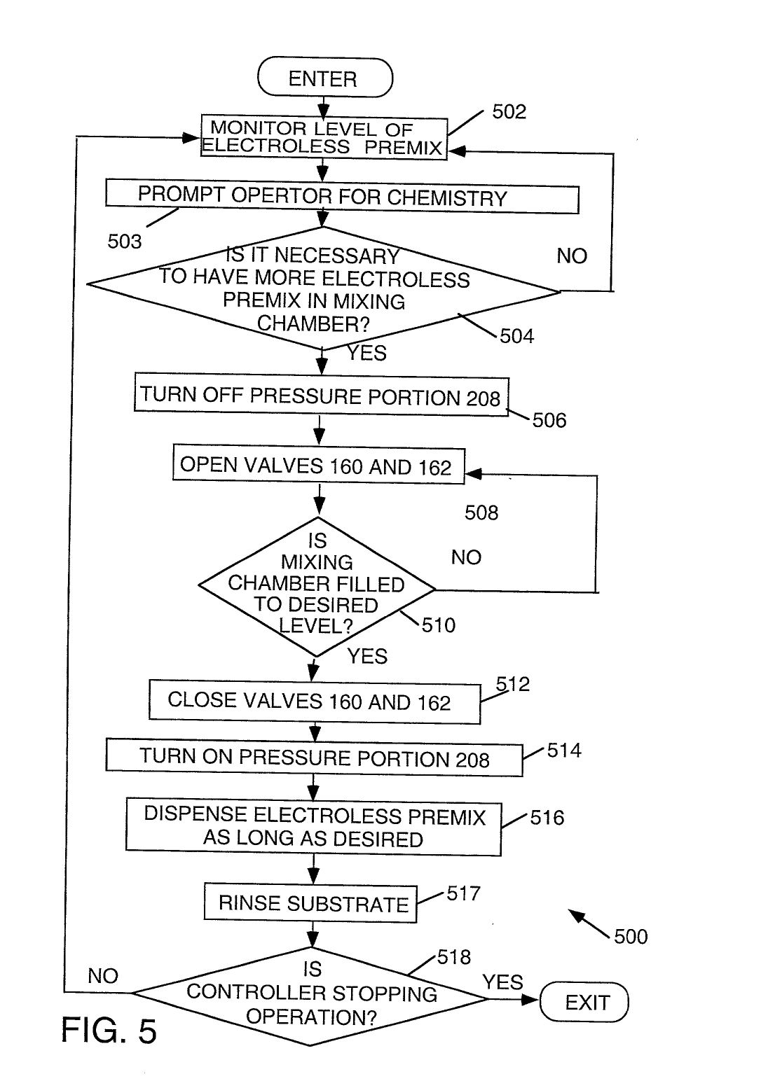

FIG. 5 shows a flow chart of one embodiment used to produce electrolyte solution using the controller 254. The controller 254 may be a general-purpose computer, a microprocessor, a microcontroller, or any other known type of computer. The CPU 260 performs the processing and arithmetic operations for the controller 254. CPU 260 is preferably of a type produced by Intel, Texas Instruments, AMD, or other such companies and whose operations is generally known to those skilled in the art.

The memory 262 includes random access memory (RAM) and read only memory (ROM) that together store the computer programs, operands, operators, dimensional values, system processing temperatures and configurations, and other parameters that control the operation of the electrolyte solution dispensing system 100. The bus 266 provides for digital information transmissions between CPU 260, circuit portion 265, memory 262, and I/O 264, and also connects I/O 264 to the portions of the electrolyte solution dispensing system 100 that either receive digital information from, or transmit digital information to, controller 254.

I/O 264 provides an interface to control the transmissions of digital information between each of the chemical source components in controller 254. I/O 264 also provides an interface between the components of the controller 254 and different portions of the electrolyte solution-dispensing system 100. Controller 254 can process information relating to the level and chemical source components included in the electrolyte solution 228 in the mixing or storing chamber 116, for example. The use of controller 254 and the associated valves ensured that a repeatable chemistry is applied as the liquid puddle regardless of the number of times that the liquid puddle is applied. Circuit portion 265 comprises all of the other user interface devices (such as display and keyboard), system devices, and other accessories associated with the controller 254. While one embodiment of digital controller 208 is described herein, other digital controllers as well as analog controllers could function well in this application, and are within the intended scope of the invention.

For a solution containing metal and reducing agents the dissolved metal and the reducing agent must occur on surface area of the object to be deposited, and not in the bulk of the solution. Hence, the surface of the object that the electrolyte solution is being applied to is known as an autocatalytic surface since deposited (and seed) material acts as a catalytic surface for further deposition of material. Since a reducing agent is always in a reactive state with the solution, prior art electroless both systems have an inherent instability. The different embodiments of electrolyte solution dispensing system 100 of the invention provides a technique by which this instability can be dealt with.

An article entitled “Electroless Copper Deposition Process Using Glyoxylic Acid as a Reducing Agent” by H. Honma et al., J. Electrochem. Soc., Vol. 141, No. 3 March 1994, pp. 730-733 (Incorporated herein by reference) describes the chemistry, temperature, pH, and other factors of one embodiment of electroless copper plating. It is envisioned that the electrolyte solution described in this article may be used, or alternatively any known electroless metal used in electroless process may be applied herein. This chemistry is now briefly summarized.

One embodiment of the chemistry associated with the electrolyte solution is now described. The metal solution supply 112 contains copper sulfate (CuSO₄) in addition to a complexing agent (e.g., ethylenediamine tetra-acetic acid (EDTA)) and a surfactant. In one embodiment, the reducing agent supply 114 contains glyoxylic acid or formaldehyde.

As described in the Honma et al. article, a mixture containing the following elements were mixed to form an electrolyte solution. The metal solution supply 112 consisting of copper sulfate was mixed with the first water supply 164 having a molecular ratio of 1 to 5 to provide a volume comprising 0.03M of the copper sulfate-water mixture (in this disclosure “M” stands for molarity). The metal solution supply 112 is mixed with 0.24M of EDTA and 0.20M of a reducing agent such as glyoxylic acid. Because the point of use mixing used in embodiments now described, the stabilizing agents that are used in most electroless baths are unnecessary. For example, cyanide is used as a stabilizing agent in most electroless baths. Due to the point of use mixing, the use of cyanide is not necessary. During the electroplating process, the temperature is preferably maintained at between 40° C. and 70° C. The pH of the electrolyte solution is adjusted to approximately 12.3 to 12.7 by the addition of KOH, NaOH, or tetramethyl or another chemical base. These source chemical components are intended to provide one embodiment, and are not intended to be limiting in scope. Any electrolyte solution known in the art (including copper or any other known metal used to produce electrolyte solution) is intended to be within the scope of the present invention.

The overall reaction produced by the combination of the source chemical components into the electrolyte solution (where glyoxylic acid is used as the reducing agent) is:

Cu²⁺+2CHOCOOH+4OH⁻→Cu⁰+2HC₂O₄₋+2H₂0+H₂↑

The standard redox potential (where glyoxylic acid is used as the reducing agent is:

CHOCOOH+3OH⁻→HC₂O₄_{⁻}+2H₂0+2e⁻=+1.01V

Deposition rate within an electrolyte solution as described above exceeds 3 μm/hour in an electroless bath, and should be similar in the liquid puddle embodiments, even where the copper ion concentration was less than 0.015M. The deposition rate may be controlled, within limits, by adjusting the concentration of the reducing agent and/or the temperature of the electrolyte solution. The relationship between deposition rate and the concentration of the complexing agent was examined at pH 12.5. In spite of the change of the complexing agent concentration, the deposition rate was almost constant.

The Honma et al. article commented glyoxylic acid as a reducing agent as easily undergoes the Cannizzaro reaction as formaldehyde:

2CHOCOOH+2OH⁻→C₂O₄_{²⁻}+HOCH₂COOH+H₂O

The consumption of reducing agent was compared using two types of pH adjusting agents (NaOH and KOH) in the article. By keeping the reducing agent separated the basic electrolyte solution as long as possible in the above point of use embodiments, the occurrence of the Cannizzaro equation is limited which keeps reducing agent more stable.

Any suitable pH-adjusting agents may be applied to the embodiment. The complexing agent included in the metal solution supply 112 is complexed with the metal (e.g., copper) ions. This ensures that the metal ions will not precipitate out after mixing to form the electrolyte solution. Complexing agents are known to maintain metals in solution. While this disclosure is specifically directed to layering electroless copper, it is intended to be within the intended scope to apply the electrolyte solution dispensing system 100 to electroless nickel, or any other known type of electroless metal or material.

The concentrations of the copper sulfate in the copper solution, and the reducing agent within the electrolyte solution 228 of one embodiment, can be precisely controlled by adjusting the flow rates of the chemical components through valves 160, 162, respectively. Such accurate control of the electrolyte solution 228 maintains the desired rate and quality of the deposited metal layer from the electrolyte solution 228.

The relative flow and timing of the respective chemicals through valves 160 and 162 in conduits 156 and 158, respectively, control the chemical makeup of the electrolyte solution 228. The more reliably the electrolyte solution 228 can be controlled, the more reliable will be the quality of the metallic layering produced by the electrolyte solution 228. During operation, small amounts of electrolyte solution 228 may be mixed (primarily by diffusion) in the mixing or storing chamber 116 either of the embodiment shown in FIG. 2 or the embodiment shown in FIG. 6. The valves 160 and 162 are then closed to limit the pressurized backflow of electrolyte solution through conduits 156 and 162 respectively. Pressure is then applied from the pressure source 208 into the mixing or storing chamber 116. The electrolyte solution 228 may then be dispensed through the conduit 168 and valve 170 when the valve 170 is open (under the influence of pressure applied from the pressure source 208 to the mixing or storing chamber 116). The pressure applied from the pressure source expels the electrolyte solution 228 to form the liquid puddle 128 on the object 124.

The mixture of the electrolyte solution 228 provided in the mixing or storing chamber 116 can be precisely controlled whether the valves 160 and 162 are operated manually or alternatively are operated under the influence of the controller 254. As noted above, the mixing operation within the mixing or storing chamber 116 can be largely eliminated in one embodiment by having an operator manually mix the electrolyte solution. The electrolyte solution is then inserted into the mixing or storing chamber 116 directly through a sealable port (not shown) formed in the mixing or storing chamber 116. The remainder of the specification describes the operations performed by the controller 254. In the embodiments that do not have a controller 254, the human operator performs similar operations as performed by the controller 254.

In an alternate embodiment of the invention, the constituents of the metal solution from the metal solution supply 112, the reducing agent from the reducing agent supply 114, and the water from the first water supply 164 may be mixed separately in a beaker (not shown) in desired ratios and quantities. This embodiment provides another example of a point of use application technique. The contents of the beaker can then be emptied directly into the mixing or storing chamber 116 through a sealable port, not shown. After the sealable port is closed, pressure may be applied from the pressure source 208 (see FIG. 2) to the mixing or storing chamber 116, as desired. The pressure source may comprise a pump, a vacuum source, etc. This embodiment obviates the need for the chemical source component 105 shown in FIG. 1.

An important consideration in applying the liquid puddle 126 of electrolyte solution 228 across the object 124 is ensuring that the electrolyte solution containing the metal (e.g. copper) is applied to the object as uniformly in thickness and chemical composition as possible. Displacement member 122 vibrates, oscillates of rotates to impart motion as indicated by arrow 142 in certain embodiment as described above. This oscillatory motion is also applied to the object 124 and the liquid puddle 126.

This oscillatory, vibrational, or rotational motion results in an agitation of the electrolyte solution 228 included in the liquid puddle 126, thereby dispensing the liquid puddle more uniformly across the entire object 124. The agitation caused by the oscillation or vibration assists in covering the entire upper surface 199 of the object 124 with the electrolyte solution 228 while decreasing the amount of expensive electrolyte solution 228.

Less electrolyte solution is typically used to form a uniform puddle 126 in the electrolyte solution dispensing systems 100 that have a pedestal that vibrates, oscillates, or rotates compared to those electrolyte solution dispensing systems in which the pedestal does not vibrate or oscillate. Because of design, the above embodiments can drive down the costs of the consumables. As a result, we can tightly control the process. Any type of mechanism that imparts an oscillatory motion to the displacement member 122 is within the scope of the invention. The rate of vibration, oscillation, or rotation must be sufficient to spread the liquid puddle 126 substantially uniformly across an upper surface 199 of the object 124. An oscillatory or vibratory rate of the displaceable member 120 ranging from 0 RPM to 300 RPM has been found suitable.

FIGS. 4A and 4B depicts a progression comprising application of the electrolyte solution 228 on an upper surface 199 of the object 124, including feature 402. As shown in FIG. 4A, the feature 402 is defined by side walls 404, 406, and a bottom wall 408. The electrolyte solution 228 is applied to the feature 402 as the liquid puddle 126. The agitation of the electrolyte solution 228 (applied by oscillatory motion of the displacement member 122 in the direction indicated by arrow 142 shown in FIG. 1) contained in the liquid puddle 126 on the object 124 also assists in the electrolyte solution 228 entering the features 402. Any feature 402 that is covered with the liquid puddle is assumed to be completely filled by electrolyte solution 228. Such features in ULSI technology have a dimension in the neighborhood of 0.13μ. Once a particular feature is filled with electrolyte solution 228, the rate of deposition of the deposited material 410 is the same on the side walls 404, the bottom wall 408, and the upper surface 199. Since electrolyte solution 228 deposits a conformal layer, the layering of the deposited material 410 is determined by surface kinetics.

The system and method been found especially applicable to layer between 50 and several hundred angstroms of electroless copper deposited material 410 (or other electroless deposited material) consistently over the upper surface 199 of the object 124, and through the features 402 formed therein.

After a prescribed deposition period of the copper onto the object as shown in FIG. 4A, deionized water from second water supply 118 and conduit 172 is applied to the object 124 to wash off the electrolyte solution. A deposited layer 410 remains on the upper surface 199, and in the features 402, after the electrolyte solution is rinsed off with the deionized water from the second water supply 118.

FIGS. 3A, 3B, and 3C illustrate another embodiment showing a progression of depositing a metal upon the object 124 using the electrolyte solution 228. The consistent electrolyte solution 228 deposition layer shown in FIG. 4B is important to not only providing an initial layer of deposited material 410, but also for patching the discontinuities 310 in the thin seed layer 308. Such discontinuities are typically formed on the sidewall 304, 306 of features 302 as shown in FIG. 3A. Such patching is important to ensure a desired electrical connection across the feature 302.

In FIG. 3A, the thin seed layer 308 of metal may initially be applied to feature 302 by a process such as physical vapor deposition (PVD) or chemical vapor deposition (CVD) after which the copper can be deposited using the electrolyte solution dispensing system 100 described herein. The operation of a PVD process is generally known and will not be further detailed here. The thin seed layer 308 initially may contain one or more discontinuity 310 since certain prior art deposition processes are incapable of applying a depsited layer evenly across the entire topography of the object 124 (including e.g. the walls 304 of the features).

The initially thin seed 308 layer shown in FIG. 3A acts attracts, and adheres to, the copper applied by the electrolyte solution dispensing system 100 as shown in FIG. 3B. After the electrolyte solution 228 is applied in the liquid puddle 126, as shown in FIG. 1 for a prescribed time, and the object 124 is agitated by oscillatory motion applied by the displacement member 122 in an oscillatory direction indicated in FIG. 1 by the arrow 142. Due to this agitation, the electrolyte solution 228, in the form of liquid puddle 126, fully settles into the features 402 formed in the object 124 as shown in FIG. 3B.

After the liquid puddle 126 is maintained on the object 124 for a prescribed time, deionized water from second water supply 118 is applied to the object 124 to rinse the liquid puddle 126 from the object 124. A metallic layer 318 including the original seed layer 308 shown in FIG. 3A in addition to deposited metal provided by the electrolyte solution 228 applied in FIG. 3B, remains attached to the object 124. The metallic layer 318 remaining in FIG. 3C, is thicker and more consistent than the original seed layer shown in FIG. 3A.

As such, the well adhered metal seed layer 308 formed by a prior art PVD or CVD system can be built up to the desired thickness by the latter well adhered copper layers provided by present invention electrolyte solution dispensing system 100 shown in FIG. 1. While the resultant metal layer 318 may not be as smooth as shown in FIG. 3C, it will be continues and securely affixed to the object 124. Such a copper to copper bond provided by one embodiment of the electrolyte solution dispensing system 100 is considerably stronger than certain of the prior art electroless systems that rely upon the palladium catalyst as described previously.

FIG. 5 shows one embodiment of a method 500, performed by the controller 254 (or human operator in those systems without controllers), used to control the operation of the electrolyte solution dispensing system 100 using a mixing or storing chamber 116 as shown in FIGS. 1 and 2. Applying the FIG. 5 method to a mixing or storing chamber of the type shown in FIG. 6 involves slight modifications of the FIG. 5 method. The modifications are associated with transferring fluids between the first mixing or storing chamber 668 and the second mixing or storing chamber 662 (which will not be further detailed herein for brevity). The level of the electrolyte solution 228, contained within the mixing or storing chamber 116, is monitored by the level sensors 220, shown in FIG. 2 at step 502.

The method continues to step 503 in which the operator inputs into the controller 254 any desired range of level 226 of the electrolyte solution 228. The controller 254 prompts the operator for the chemical make-up of the electrolyte solution. If the operator has changed the chemical make-up of the electrolyte solution, then the controller 254 modifies the conditions within the interior space 193 of the object support portion 102. The conditions within the interior space 193 may be changed by the operator by, e.g. varying the heat in the heating elements 132 which transfer heat by conduction, in turn, to the pedestal 120, to the object 124, and finally to the liquid puddle 228. Applying heat to the liquid puddle may enhance/or even make possible a chemical reaction within the electrolyte solution. The temperature and/or the pressure that the object 124 is maintained at may be altered by applying heat (for example by heating element, not shown) or pressure (from pressure source-not shown) in a manner that is generally known. The chemistry of the electrolyte solution may be altered by switching the timing or position of valves 160, 162, and 163 and/or providing different sources for chemicals to be inserted into the mixing chamber 116. If the chemistry of the electrolyte solution within the mixing chamber 116 is to be changed, then it may be necessary to purge the contents of the mixing chamber 116 from a purge port (not shown) such that new electrolyte solution of a desired chemistry can be mixed from scratch. In this manner, the operating parameters of the object support portion 102 of the electrolyte solution dispensing system 100 is controlled by the controller 254, possibly by prompting the operator.

The method 500 continues to decision step 504 in which controller 254 determines whether to input more electrolyte solution 228 into the mixing or storing chamber 116. If the answer to decision step 504 is “NO”, then the method 500 continues to monitoring step 502. If, by comparison, the controller 254 (or human operator) determines that the level 226 has fallen below the desired minimum upper level in decision step 504, then the method 500 continues to step 506.

In step 506, gas from the pressure source 208 in FIG. 2 is no longer applied to the mixing or storing chamber 116, and the pressure in the mixing or storing chamber is vented to atmosphere. This pressure reduction in the mixing or storing chamber 116 limits the possible backflow of electrolyte solution 228 into the metal solution supply 112 and the reducing agent supply 114. This backflow would contaminate the contents of the supplies 112 and 114.

Method 500 then continues to step 508 in which the valves 160, 162, and 163 are open to dispense the contents of the metal solution supply 112, the reducing agent supply 114, and the first water supply 164 into the mixing or storing chamber 116. This action forms the electrolyte solution 228 of the desired chemistry. For example, the chemicals used in the Honma et al. article, or any other known electrolyte solution may be used. The chemicals are then mixed, and thereby form the electrolyte solution 228. This mixing to form electrolyte solution occurs primarily by diffusion, though the mixing or storing chamber 116 can be formed with, e.g., baffles, to assist in the mixing process. The method 500 continues to decision step 510 in which the controller 254 determines whether the level 226 of the electrolyte solution 228 in the mixing or storing chamber 116 is at a maximum level. Once again, level sensors 220 determine the level 226 of the electrolyte solution. Step 508 and decision step 510 form a processing loop that continues until the level 226 of the electrolyte solution 228 in the mixing or storing chamber 116 is raised to a maximum level.

The method 500 then continues to step 512, in which the valves 160, 162, and 163 are closed, at which time pressure can once again be re-applied to the mixing or storing chamber 116 from the process portion 208 without the risk of backflow into conduits 156 and 158, respectively. The method then continues to step 514 is which the pressure from the pressure source 208 is applied to the mixing or storing chamber 116. The pressure that must be applied to the mixing or storing chamber 116 is a design choice depending upon the design of the mixing or storing chamber 116 and the constituency of the electrolyte solution contained therein. The pressure, however, must be sufficient to expel the electrolyte solution smoothly through the conduit 168 when the valve 170 is opened.

Method 500 continues to step 516, in which valve 170 is opened such that operator can dispense the electrolyte solution 228 from the mixing or storing chamber 116. The amount of electrolyte solution 228 that is dispensed is, once again, a design choice. However, the amount should be sufficient to form the liquid puddle 126 on the object 124. During step 516 and soon thereafter, the controller 254 causes the displacement member 122 to vibrate or oscillate as shown by the arrow 142, which agitates the contents of the liquid puddle 126 on the object 124. This agitation of the liquid puddle 126 is sufficient to ensure that the electrolyte solution 228 flowing out through conduit 168 (and defining the liquid puddle) covers the entire surface to be plated of the object. The agitation is also sufficient to ensure that the electrolyte solution 228 contained in the liquid puddle fills all of the features 402 of the object 124, as shown in FIG. 4. Method continues to step 517 in which rinse water from the second water supply 118 is applied to the upper surface of the object 124 (by opening valve 174) to wash away the liquid puddle 126. This step may be performed at a preselected time after the liquid puddle 126 is applied to the object 124, in step 516. Alternatively, the operator may control the application of step 517 manually.

The method 500 continues to decision step 518 in which the controller 254 determines whether the operator wishes to continue processing using the electrolyte solution dispensing system 100. If the answer to decision step 100 is “NO”, then method 500 proceeds to monitoring step 500 as described above, and the method 500 continues. If the answer to decision step 518 is “YES”, then method 500 proceeds to terminate the method 500.

While the operation of controller 254 has been described in detail relative to FIG. 5, it is within the scope of the invention that a skilled operator may override the operation of the electrolyte solution dispensing system 100. Additionally, the electrolyte solution dispensing system 100 may be utilized in a simplified embodiment that has no controller 254.

Although various embodiments that incorporate the teachings of the invention have been shown and described in detail herein, those skilled in the art can readily devise many other varied embodiments that still incorporate these teachings.

What is claimed is:

1. An apparatus for dispensing an electrolyte solution on an object, the apparatus comprising:
a storage chamber configured to hold the electrolyte solution; and
a dispensing portion configured to dispense the electrolyte solution on the object.

2. The apparatus set forth in claim 1, wherein the electrolyte solution comprises a metal solution.

3. The apparatus set forth in claim 1, wherein the electrolyte solution comprises a reducing agent.

4. The apparatus set forth in claim 1, wherein the dispensing portion applies the electrolyte solution to an upper surface of the object.

5. The apparatus set forth in claim 4, further comprising an agitation device applies an oscillatory or vibrational motion to the object.

6. The apparatus set forth in claim 5, wherein said oscillatory or vibrational motion distributes the electrolyte solution over the object.

7. The apparatus set forth in claim 1, further comprising a rinse device.

8. The apparatus set forth in claim 1, wherein the storage chamber comprises a mixing chamber.

9. The apparatus set forth in claim 1, wherein the electrolyte solution comprises a plurality of liquids comprising a metal solution and a reducing agent that are mixed in the storage chamber.

10. The apparatus set forth in claim 1, wherein the apparatus further comprises a distribution portion that distributes the electrolyte solution over the object.

11. The apparatus set forth in claim 1, further comprising a pressure source coupled to the storage chamber.

12. The apparatus set forth in claim 11, wherein the pressure source acts to dispense the electrolyte solution through the dispensing portion.

13. The apparatus set forth in claim 1, further comprising an enclosure enclosing an area adjacent to the object that limits the rate of evaporation of the electrolyte solution from the object.

14. The apparatus set forth in claim 1, wherein the object is a substrate.

15. A method of applying an electrolyte solution onto an object, the method comprising:
storing electrolyte solution in a storage chamber; and
dispensing said electrolyte solution stored in the storage chamber onto the object.

16. The method set forth in claim 15, further comprising agitating the object after the electrolyte solution has been deposited thereupon.

17. The method set forth in claim 16, wherein the agitating the object comprises oscillating or vibrating the object.

18. The method set forth in claim 15, wherein the electrolyte solution dispensed upon the object takes the form of a puddle.

19. The method set forth in claim 15, wherein the dispensing the electrolyte solution on the object further comprises patching a seed layer on the object.

20. The method set forth in claim 19, wherein the electrolyte solution is stored in a manner that enhances its stability.

21. The method set forth in claim 15, further comprising dispensing a rinse over the object.

22. The method set forth in claim 15, wherein the storing of the electrolyte solution comprises mixing the electrolyte solution.

23. The method set forth in claim 15, further comprising depositing a seed layer on the object.

24. The method set forth in claim 15, wherein the object is a substrate.

25. A method of applying an electrolyte solution to a object that has a plating surface, the method comprising:
positioning the object in a substantially horizontal position; and
dispensing a liquid puddle of the electrolyte solution over the plating surface.

26. The method set forth in claim 25, further comprising oscillating the object after the dispensing the electrolyte solution.

27. The method set forth in claim 25, further comprising distributing the liquid puddle over the plating surface.

28. The method set forth in claim 25, further comprising rinsing the object.

29. The method set forth in claim 25, further comprising limiting evaporation of the liquid puddle.

30. The method set forth in claim 25, wherein the electrolyte solution is stored in a manner that enhances its stability.

31. A computer readable medium that stores software that, when executed by a processor, causes a system to perform a method comprising:
storing an electrolyte solution in a storage chamber, the electrolyte solution having a chemistry that is controlled by the computer-based controller; and
dispensing the electrolyte solution stored in the storage chamber onto the object under the control of the computer-based controller.

32. The computer readable medium set forth in claim 31, wherein the method further comprises dispersing the electrolyte solution over the object under the control of the computer-based controller.
